(19) United States
(12) Patent Application Publication
(10) Pub. No.: US 2025/0141341 A1
(43) Pub. Date: May 1, 2025

(54) POWER SUPPLY DEVICE

(71) Applicant: TMEIC Corporation, Tokyo (JP)

(72) Inventors: Takashi TOMITA, Chuo-ku (JP); Chihiro HASEGAWA, Chuo-ku (JP); Kazuhiro USUKI, Chuo-ku (JP)

(73) Assignee: TMEIC Corporation, Tokyo (JP)

(21) Appl. No.: 18/837,646

(22) PCT Filed: Oct. 6, 2022
(86) PCT No.: PCT/JP2022/037416

§ 371 Date: Aug. 12, 2024

(51) Int. Cl. H02M 1/14; H02M 3/155; H02M 7/04

(52) U.S. Cl. CPC H02M 1/14; H02M 3/155; H02M 7/05

(57) ABSTRACT

A power supply device according to an embodiment is configured to supply DC power to an electrolytic cell producing hydrogen by electrolysis. The power supply device includes a power converter, a reactor, and a filter circuit; the power converter is self-commutated and includes a first output terminal and a second output terminal; the second output terminal is configured to output a positive voltage with respect to the first output terminal; the reactor is connected in series to at least one of the first output terminal or the second output terminal; and the filter circuit is connected between an anode and a cathode of the electrolytic cell. The filter circuit is a low-pass filter. A cutoff frequency of the filter circuit is set to be less than a switching frequency of the power converter.

### TECHNICAL FIELD

An embodiment of the invention relates to a power supply device configured to supply power to an electrolytic cell of a hydrogen production plant.

### BACKGROUND ART

A power supply device is used in a hydrogen production plant using an electrolysis reaction. An electrolytic cell of the hydrogen production plant includes many cells. For example, these cells each include an anode and a cathode; and a partition such as an ion exchange membrane or the like is located between the anode and the cathode. The electrolytic cell is configured by connecting these cells in series and then in parallel.

In such hydrogen production by an electrolysis reaction, the reaction efficiency of the electrolysis changes according to the magnitude of the current value supplied to the electrolytic cell. It is desirable for the power supply device to output a current having a larger value.

Components included in a power supply device that includes self-commutated power conversion circuits can be made smaller by increasing the switching frequency. For example, an inductance value necessary for a reactor located at the output side of the power supply device can be reduced by increasing the switching frequency; and the reactor can be smaller.

The current that is output by the power supply device includes a ripple current that is dependent on the switching frequency. The ripple current that is superimposed onto the output current is determined by the switching frequency and the inductance value of the output reactor.

The peak value of the ripple current flowing in the reactor is increased when the switching frequency of the power supply device is increased and the inductance value of the output reactor is reduced. When the ripple current is large, the life of the electrodes included in the electrolytic cell is reduced. Therefore, a power supply device that increases the current value supplied to the electrolytic cell while suppressing the ripple current is necessary.

### CITATION LIST

### Patent Literature

[Patent Literature 1]
JP-A 2021-531713 (Kohyo)

### SUMMARY OF INVENTION

### Problem to be Solved by the Invention

An embodiment is directed to obtain a power supply device that can supply a current having low ripple to an electrolytic cell of a hydrogen production plant.

### Means for Solving the Problem

A power supply device according to an embodiment of the invention is configured to supply DC power to an electrolytic cell producing hydrogen by electrolysis. The power supply device includes a power converter, a reactor, and a filter circuit; the power converter is self-commutated and includes a first output terminal and a second output terminal; the second output terminal is configured to output a positive voltage with respect to the first output terminal; the reactor is connected in series to at least one of the first output terminal or the second output terminal; and the filter circuit is connected between an anode and a cathode of the electrolytic cell. The filter circuit is a low-pass filter. A cutoff frequency of the filter circuit is set to be less than a switching frequency of the power converter.

### Effects of the Invention

According to an embodiment, a power supply device that can supply a current having low ripple to an electrolytic cell of a hydrogen production plant is realized.

### BRIEF DESCRIPTION OF DRAWINGS

FIG. 1 is a schematic block diagram illustrating a power supply device according to a first embodiment.

FIG. 2 is a schematic block diagram illustrating a power supply device according to a second embodiment.

FIG. 3 is a schematic block diagram for describing an operation of the power supply device according to the second embodiment.

### DETAILED DESCRIPTION

Various embodiments are described below with reference to the accompanying drawings.

The drawings are schematic or conceptual; and the relationships between the thickness and width of portions, the proportions of sizes among portions, etc., are not necessarily the same as the actual values. Also, the dimensions and proportions may be illustrated differently among drawings, even when the same portion is illustrated.

In the specification and drawings, components similar to those described previously or illustrated in an antecedent drawing are marked with the same reference numerals; and a detailed description is omitted as appropriate.

### First Embodiment

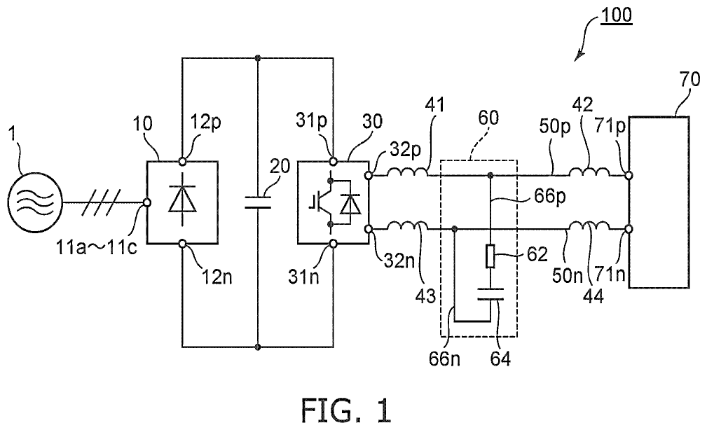

FIG. 1 is a schematic block diagram illustrating a power supply device according to a first embodiment.

In addition to the power supply device 100 according to the embodiment, FIG. 1 shows, as a load, an electrolytic cell 70 that produces hydrogen by receiving power supplied by the power supply device 100. The electrolytic cell 70 is connected to the output of the power supply device 100 via an anode terminal 71p and a cathode terminal 71n.

In the example, the power supply device 100 is connected to an AC power supply 1. The AC power supply 1 outputs three-phase alternating current. The power supply device 100 converts the AC power supplied from the AC power supply 1 into DC power, and supplies the DC power to the electrolytic cell 70. For example, the power supply device 100 supplies the power to the electrolytic cell 70 by appropriately switching between constant current control, constant power control, and constant voltage control according to the state of the electrolysis reaction of the electrolytic cell 70.

The configuration of the power supply device 100 will now be described.

The power supply device 100 includes a power converter 30, reactors 41 to 44, and a filter circuit 60. In the example, the power supply device 100 further includes a rectifying circuit 10 and a smoothing capacitor 20.

The power converter 30 includes output terminals 32p and 32n. A positive-side bus bar 50p is connected to the output terminal 32p. The output terminal 32p is connected to the anode terminal 71p of the electrolytic cell 70 via the bus bar 50p. A negative-side bus bar 50n is connected to the output terminal 32n. The output terminal 32n is connected to the cathode terminal 71n of the electrolytic cell 70 via the bus bar 50n.

The reactors 41 and 42 are connected in series to the positive-side bus bar 50p. Reactors 43 and 44 are connected in series to the negative side bus bar 50n. Favorably, the bus bar 50p and the bus bar 50n are parallel conductors overlaid with an insulator interposed, and are, for example, a laminated bus bar. When the bus bar 50p and the bus bar 50n are parallel conductors, it is favorable for the reactor to be split and provided for each bus bar as in the example. By splitting the reactor and by making the bus bars 50p and 50n parallel conductors, the effects of parasitic inductance due to the bus bar arrangement can be reduced.

The filter circuit 60 is connected between the positive-side bus bar 50p and the negative side bus bar 50n. That is, the filter circuit 60 is connected between the electrolytic cell 70 and the output of the power converter 30. In the example, one bus of the filter circuit 60 is connected to a connection node of the reactors 41 and 42; and the other bus of the filter circuit is connected to a connection node of the reactors 43 and 44. The connection location of the filter circuit 60 is not limited to the aforementioned, and it is sufficient to connect the filter circuit 60 at a position such that the filter circuit 60 can bypass the ripple current flowing in the reactors. For example, one bus of the filter circuit 60 may be connected between the reactor 42 and the anode terminal 71p and connected between the reactor 44 and the cathode terminal 71n.

The filter circuit 60 includes a resistor 62 and a capacitor 64. The resistor 62 and the capacitor 64 are connected in series. The series circuit of the resistor 62 and the capacitor 64 is connected to the positive-side bus bar 50p by a positive-side bus 66p. The series circuit of the resistor 62 and the capacitor 64 is connected to the negative bus bar 50n by a negative-side bus 66n.

It is favorable for the positive-side bus 66p and the negative-side bus 66n to be parallel conductors overlaid with an insulator interposed, e.g., a laminated bus bar. By making the positive-side bus 66p and the negative-side bus 66n parallel conductors, the effects of the parasitic inductance of the bus can be reduced.

The filter circuit 60 is a low-pass filter made of the series circuit of the resistor 62 and the capacitor 64. The cutoff frequency of the low-pass filter is set to a value less than the switching frequency of the power converter 30. When the power supply device 100 is realized using multiple power converters that are connected in parallel and multiplexed, the cutoff frequency of the low-pass filter is set to a value less than the multiplexed switching frequency. The cutoff frequency of the filter circuit 60 is set by the resistance value of the resistor 62 and the electrostatic capacitance value of the capacitor 64.

In the power supply device 100 according to the embodiment, the rectifying circuit 10 is connected to the AC power supply 1 via the AC input terminals 11a to 11c. The rectifying circuit 10 rectifies the three-phase AC voltage input from the AC power supply 1 into rectified current, and outputs the rectified current to the smoothing capacitor 20. The smoothing capacitor 20 is connected via output terminals 12p and 12n of the rectifying circuit 10. The smoothing capacitor 20 converts the rectified current output from the rectifying circuit 10 into a DC voltage, and outputs the DC voltage to the power converter 30.

According to the embodiment, the power supply device 100 converts the AC power output by the AC power supply 1 into DC power, and outputs the DC power to the electrolytic cell 70. The power that is supplied to the power converter 30 is not limited to being from the AC power supply 1 as in the example, and may be DC power. For example, an output of a solar power generation device may be connected to the input of the power converter 30 instead of the AC power supply 1, the rectifying circuit 10, and the smoothing capacitor 20.

The power converter 30 converts the DC power output from the smoothing capacitor 20 into the desired current value, voltage value, or power value, and supplies the desired current value, voltage value, or power value to the electrolytic cell 70. The power converter 30 includes, for example, a chopper conversion circuit, e.g., a buck chopper circuit. It is favorable for the conversion circuit of the power converter 30 to use a technique that reduces the ripple component of the output current.

The reactors 41 to 44 that are connected to the output of the power converter 30 function as a choke coil of the buck chopper circuit. It is favorable to set the inductance values of the reactors 41 to 44 to increase values from the perspective of reducing the ripple current.

Effects of the power supply device 100 according to the embodiment will now be described.

The power supply device 100 according to the embodiment includes the filter circuit 60 at the output. The power supply device 100 supplies DC power to the electrolytic cell 70 via the filter circuit 60. The filter circuit 60 has a cutoff frequency set to be less than the switching frequency of the power converter 30. Therefore, the filter circuit 60 bypasses ripple current having the reciprocal of the switching frequency of the power converter 30 as one period. The power supply device 100 can avoid causing a ripple current to flow in the electrolytic cell 70.

In the power supply device 100 according to the embodiment, the ripple current can be bypassed by the filter circuit 60, and so degradation of the electrodes of the electrolytic cell due to the ripple current can be suppressed, and a longer electrode life is possible. Also, the constant current value that is supplied to the load can be set to be larger by an amount based on the ripple current component. Therefore, the electrolysis reaction of the electrolytic cell 70 can proceed faster, and the production efficiency of the hydrogen production can be increased.

In the power supply device 100 according to the embodiment, a filter circuit is used to reduce the ripple component of the output current, and so the device can be smaller because it is unnecessary to increase the inductance values of the reactors 41 to 44.

Also, in the power supply device 100 according to the embodiment, the filter circuit 60 is included at the output, and so it is unnecessary to increase switching frequency of the power converter 30 for the ripple current. Therefore, a reduction of the power conversion efficiency due to an increase of the switching loss occurring due to an increased switching frequency can be prevented.

### Second Embodiment

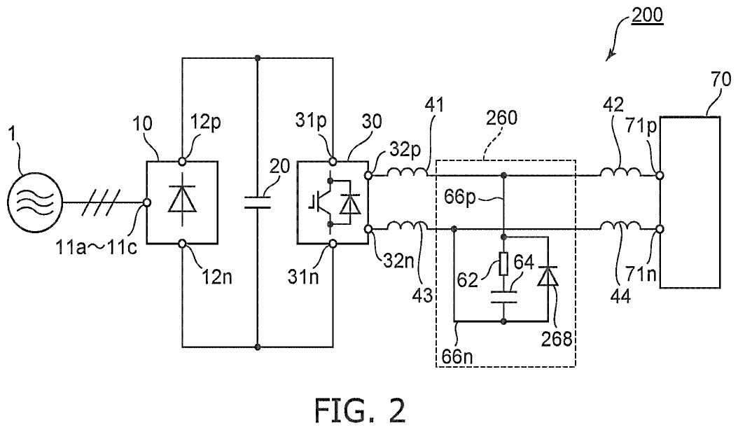

FIG. 2 is a schematic block diagram illustrating a power supply device according to a second embodiment.

As shown in FIG. 2, the configuration of a filter circuit 260 of the power supply device 200 according to the embodiment is different from that of the power supply device 100 according to the first embodiment. Otherwise, the power supply device 200 according to the embodiment has the same configuration as the power supply device 100 according to the first embodiment; the same components are marked with the same reference numerals; and a detailed description is omitted as appropriate.

The power supply device 200 includes the power converter 30, the reactors 41 to 44, and the filter circuit 260. In the example as well, similarly to the power supply device 100 according to the first embodiment, the power supply device 200 further includes the rectifying circuit 10 and the smoothing capacitor 20, converts the AC power supplied from the three-phase AC power supply 1 into DC power, and outputs the DC power to the electrolytic cell 70.

The filter circuit 260 is connected between the positive-side bus bar 50p and the negative side bus bar 50n similarly to the power supply device 100 according to the first embodiment. That is, the filter circuit 260 is connected between the electrolytic cell 70 and the output of the power converter 30.

The filter circuit 260 includes the resistor 62, the capacitor 64, and a diode 268. The resistor 62 and the capacitor 64 are connected in series. The diode 268 is connected in parallel to the series circuit of the resistor 62 and the capacitor 64. The anode of the diode 268 is connected to the negative-side bus 66n. The cathode of the diode 268 is connected to the positive-side bus 66p. When a short-circuit fault occurs in the load, the diode 268 prevents an excessive voltage from being applied to the filter circuit 260 by bypassing the current flowing in the reactors 41 to 44.

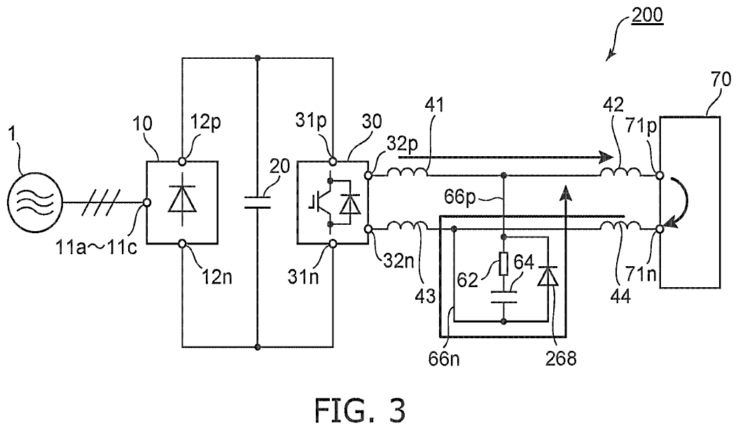

FIG. 3 is a schematic block diagram for describing an operation of the power supply device according to the second embodiment.

The operation of the power supply device 200 according to the embodiment will now be described using FIG. 3.

As shown in FIG. 3, the diode 268 of the filter circuit 260 operates when the electrolytic cell 70 is shorted. The low-pass filter that is made of the series circuit of the resistor 62 and the capacitor 64 operates when the electrolytic cell 70 is normal; the operation is similar to that of the filter circuit 60 of the power supply device 100 according to the first embodiment; and a detailed description is omitted.

The power supply device 200 outputs DC power to the load until the electrolytic cell 70 short-circuits. Therefore, currents flow in the reactors 41 to 44 in directions that flow into the anode of the electrolytic cell 70 and out of the cathode of the electrolytic cell 70.

When the electrolytic cell 70 short-circuits, the power converter 30 continues to carry current until stopped by overcurrent protection or the like, and so a current flows as illustrated by the thick arrows of FIG. 3. The diode 268 bypasses this current and prevents an excessive voltage from being applied to the capacitor 64.

Effects of the power supply device 200 according to the embodiment will now be described.

The power supply device 200 according to the embodiment provides effects similar to those of the power supply device 100 according to the first embodiment. Also, in the power supply device 200, the filter circuit 260 includes the diode 268. If the electrolytic cell 70 short-circuit faults when there is no diode 268, the capacitor 64 is discharged and then charged with reverse polarity, and so an excessive reverse voltage is applied to the capacitor 64; and the output of the power supply device 200 also is affected.

The power supply device 200 according to the embodiment prevents the fault from spreading to the power converter 30 because the diode 268 bypasses the charge current of the capacitor 64 when a short-circuit occurs. Accordingly, the power supply device 200 can be safely protected even when a short-circuit fault occurs due to a fault in a cell inside the electrolytic cell 70, a connection fault of wiring, etc.

Thus, a power supply device that can supply a current having low ripple to an electrolytic cell of a hydrogen production plant is realized.

While certain embodiments of the inventions have been described, these embodiments have been presented by way of example only, and are not intended to limit the scope of the inventions. These novel embodiments may be embodied in a variety of other forms; and various omissions, substitutions, and changes may be made without departing from the spirit of the inventions. Such embodiments and their modifications are within the scope and spirit of the inventions, and are within the scope of the inventions described in the claims and their equivalents.

### REFERENCE NUMERAL LIST

1 AC power supply
10 rectifying circuit
20 smoothing capacitor
30 power converter
41 to 44 reactor
60, 260 filter circuit
70 electrolytic cell
100, 200 power supply device
268 diode

1. A power supply device configured to supply direct current power to an electrolytic cell, the electrolytic cell producing hydrogen by an electrolysis reaction, the power supply device comprising:
a power converter including a first output terminal and a second output terminal, the second output terminal being configured to output a positive voltage with respect to the first output terminal, the power converter being self-commutated;
a reactor connected in series to at least one of the first output terminal or the second output terminal; and
a filter circuit connected between an anode and a cathode of the electrolytic cell,
the filter circuit being a low-pass filter,
a cutoff frequency of the filter circuit being set to be less than a switching frequency of the power converter.

2. The power supply device according to claim 1, wherein
the filter circuit includes a series circuit of a resistor and a capacitor.

3. The power supply device according to claim 2, wherein
in the filter circuit, one of two ends of the series circuit is connected to the first output terminal by a first bus, and the other of the two ends of the series circuit is connected to the second output terminal by a second bus, and
the first bus and the second bus are parallel conductors.

4. The power supply device according to claim 2, wherein
the filter circuit includes a diode connected in parallel to the series circuit,
an anode of the diode is connected to the first output terminal, and
a cathode of the diode is connected to the second output terminal.

5. The power supply device according to claim 1, wherein
the power converter includes a buck chopper circuit.
